(19) United States
(12) Patent Application Publication
(10) Pub. No.: US 2026/0230033 A1
(43) Pub. Date: Aug. 6, 2026

(54) SUPPORT STRUCTURES FOR SOLAR TRACKER SYSTEMSWITH VARIABLE PITCH

(71) Applicant: Nextpower LLC, Fremont, CA (US)

(72) Inventor: Charles Almy, Berkeley, CA (US)

(21) Appl. No.: 19/445,804

(22) Filed: Jan. 12, 2026

Related U.S. Application Data
(60) Provisional application No. 63/752,480, filed on Jan. 31, 2025.

(51) Int. Cl. H02S 20/32; F24S 25/12; F24S 30/00; F24S 30/425

(52) U.S. Cl. CPC H02S 20/32; F24S 25/12; F24S 30/425; F24S 2030/15

(57) ABSTRACT

Solar trackers located on terrain of varying contour include a continuous torque tube formed of a plurality of sections; the plurality of sections being interconnected. A plurality of piers are embedded in the terrain at spaced locations along the torque tube to form a row. Top portions of the plurality of piers being at differing heights relative to each other due to the terrain of varying contour. The torque tube extending along the piers such that the torque tube and a pitch angle of a central axis follow the differing heights of the top portions. Further, each pier is mounted into the terrain at a mounting angle that is substantially 90 degrees downward from the pitch angle of the central axis proximate a location along the continuous torque tube where the pier is rotatably supported by a respective bearing.

### TECHNICAL FIELD

This application claims the benefit of U.S. Provisional Patent Application No. 63/752,480, filed Jan. 31, 2025, the entire contents of which are incorporated herein by reference.

### FIELD

This disclosure relates generally to solar power generation systems, and more particularly, to support structures having variable pitch for solar arrays within a solar tracking system.

### BACKGROUND

Solar panels can convert sunlight into energy. As an example, solar thermal panels often convert electromagnetic radiation from the sun into thermal energy for heating homes, running certain industrial processes, or driving high grade turbines to generate electricity. As another example, solar photovoltaic panels convert sunlight directly into electricity for a variety of applications. Solar panels are generally composed of an array of solar cells, which are interconnected to each other. The cells are often arranged in series and/or parallel groups of cells in series. The solar cells may comprise a solar tracker. A solar tracker is typically comprised of a torque tube that supports the solar panels and is itself supported by piers embedded into the ground. Accordingly, solar panels have great potential to benefit our nation, security, and human users. They can even diversify our energy requirements and reduce the world's dependence on oil and other potentially detrimental sources of energy.

One of the most significant, costly, and time-consuming aspects relating to the manufacture and installation of solar trackers is the requirement that the site be substantially level. While certainly some sites are generally level, most terrain has some undulation and, in some instances, quite a significant pitch to the terrain. In practical terms this required installers of solar trackers to conduct significant amount of earth excavation, moving, and grading. Such earthworks are time consuming, require significant amounts of heavy machinery, and are subject to a significant amount or regulation. Indeed, some projects have been halted owing to the environmental impact of the earthmoving required to produce a relatively level site for the installation of the solar trackers; in others, grading is forbidden.

As an alternative to massive earthworks, solar tracker piers may include custom pier heights that permit the torque tube to remain level and/or consistent. While the earthmoving costs are reduced, there are additional financial and timing costs associated with custom piers. First, these are custom length piers which require custom length determinations. Next, the custom piers need to be accurately identified and sorted with the respect to the site to they can be installed in their custom location. All of this takes resources and ultimately increases the cost of the installation.

In other examples, the solar tracker piers may be the same length, but orientated plumb. In such cases, the torque tube is segmented at each bearing (e.g., pile). This method requires custom length determinations for the torque tube segments, which may add additional financial and timing costs. Further, there may be an increase in mechanical interference (e.g., gaps) between bays of the solar tracker at points where terrain changes are relatively greater. The present disclosure seeks to address these shortcomings of prior tracker systems.

### SUMMARY

In general, the present disclosure relates to support structures for solar arrays within a solar tracking system. In one example, a solar tracker located on terrain of varying contour may include a continuous torque tube formed of a plurality of sections, the plurality of sections being interconnected and having one end which may be swaged and another end unswaged such that the swaged ends are inserted in the unswaged ends to form the continuous torque tube, the continuous torque tube defining a central axis extending longitudinally therethrough. A plurality of piers may be embedded in terrain of varying contour at spaced locations along the continuous torque tube to form a row. Each pier of the plurality of piers may have a top portion, the top portions of the first plurality of piers being at differing heights relative to each other due to the terrain of varying contour. A plurality of bearings, each bearing of the plurality of bearings may be fixedly mounted to the top portion of a respective pier of the first plurality of piers. The continuous torque tube extending along and rotatably supported at the spaced locations along the continuous torque tube by the plurality of bearings such that the continuous torque tube and a pitch angle of the central axis follow the differing heights of the top portions, and the pitch angle of the central axis may be defined as the angle of the central axis relative to the horizon. Each pier may be mounted into the terrain of varying contour at a mounting angle that may be substantially 90 degrees downward from the pitch angle of the central axis proximate a location along the continuous torque tube where the continuous torque tube is rotatably supported by a respective bearing.

Additionally or alternatively, the solar tracker may include a first section of the plurality of sections which may extend from the top portion of a first pier of the first plurality of piers to the top portion of a second pier of the plurality of piers, and a second section of the plurality of sections extending from the top portion of the second pier to the top portion of a third pier of the plurality of piers. The difference in heights of the top portions of the first pier, second pier, and third pier relative to each other and causing bending along a length of the first section and pre-loading the first section may form a relative angle between the first section and the second section to enable the continuous torque tube to follow variations in the terrain of varying contour.

Additionally or alternatively, the solar tracker may include a first section of the plurality of sections extending from the top portion of a first pier of the first plurality piers to the top portion of a second pier of the plurality of piers, and a second section of the plurality of sections extending from the top portion of the second pier to the top portion of a third pier of the plurality of piers, the difference in heights of the top portions of the first pier, second pier, and third pier relative to each other resulting in a non-zero relative angle between the first section and the second section to enable the torque tube to follow variations in the terrain of varying contour.

Additionally or alternatively, a plurality of solar panels may be coupled to the continuous torque tube.

Additionally or alternatively, the swaged ends inserted into the unswaged ends may form overlapping sections having a double-wall thickness.

Additionally or alternatively, the overlapping sections may be placed proximate the piers of the plurality of piers.

Additionally or alternatively, the pitch angle of the central axis may vary up to +60 degrees relative to the horizon.

Additionally or alternatively, some of the plurality of piers may be mounted into the terrain at a non-zero angle relative to plumb.

Additionally or alternatively, the continuous torque tube may be generally parallel to underlying terrain of varying contour.

The details of one or more examples are set forth in the accompanying drawings and the description below. Other features, objects, and advantages will be apparent from the description and drawings, and from the claims.

### BRIEF DESCRIPTION OF DRAWINGS

The following drawings are illustrative of particular embodiments of the present disclosure and, therefore, do not limit the scope of the disclosure. The drawings are intended for use in conjunction with the explanations in the following description. Embodiments of the disclosure will hereinafter be described in conjunction with the appended drawings, wherein like numerals denote like elements. The features illustrated in the drawings are not necessarily to scale, though embodiments within the scope of the present disclosure can include one or more of the illustrated features at the scale shown. Various aspects and features of the present disclosure are described hereinbelow with reference to the drawings, wherein:

FIG. 1 is an elevation view of a solar tracker provided in accordance with the present disclosure;

FIG. 2 is a schematic, top view of a solar tracking system;

FIG. 3 is a profile view of a solar tracker on rolling terrain;

FIG. 4 is a side view of an example clamp assembly coupled to a solar tracker pier, including a portion of a torque tube, where the solar tracker pier and the torque tube are aligned at a 90-degree angle;

FIG. 5 is an enlarged profile view of a solar tracker on rolling terrain;

FIG. 6 is an enlarged view of a portion of a solar tracker pier including a portion of a torque tube on uneven terrain;

FIG. 7 is an enlarged view of a portion of a solar tracker pier including a portion of a torque tube on uneven terrain;

FIG. 8 is an enlarged view of a portion of a solar tracker pier including a portion of a torque tube on even terrain; and

FIG. 9 is a profile view of a solar tracking system on a sloping terrain.

### DETAILED DESCRIPTION

The following detailed description is exemplary in nature and is not intended to limit the scope, applicability, or configuration of the disclosure in any way. Rather, the following description provides some practical illustrations for implementing examples of the present disclosure. Those skilled in the art will recognize that many of the noted examples have a variety of suitable alternatives.

Embodiments disclosed herein include various devices, systems, and methods relating to solar tracker foundations. Certain embodiments disclosed herein relate to solar tracker supports configured to facilitate improved structural stability for solar tracking systems. Certain embodiments disclosed herein can improve solar tracking system structural stability while increasing the efficiency of solar tracking foundation installation and reducing costs (e.g., foundation and/or support material costs) associated with solar tracker foundations and supports.

This disclosure is directed to solar tracker systems configured to maintain a substantially 90-degree angle between a torque tube and a solar tracker pier on generally level terrain as well as terrain that has some undulation and, in some instances, quite a significant pitch to the terrain. The system and methods disclosed herein calculate a pitch for each foundation point, taking into account a terrain delta from North to South to maintain perpendicularity of the pier to the torque tube.

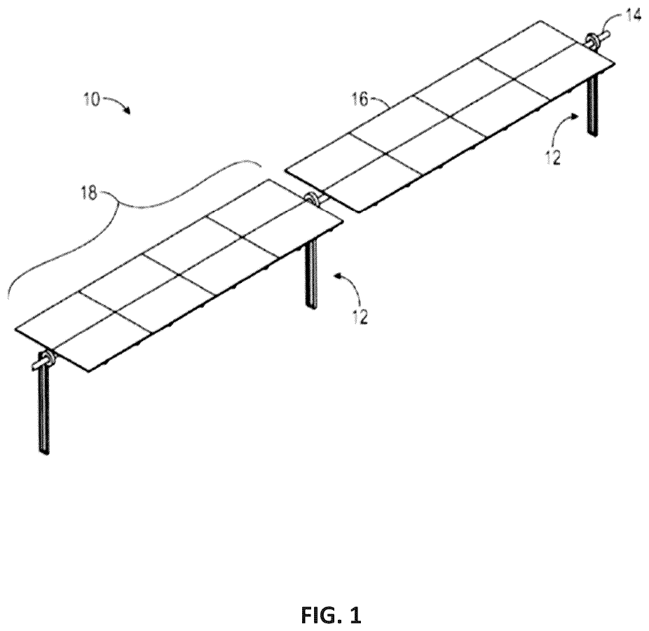

FIG. 1 is an elevation view of a common arrangement of a solar tracker 10 provided in accordance with the present disclosure. In some applications, a plurality of solar trackers 10 may be arranged in a north-south longitudinal orientation to form rows of a solar array. The solar tracker 10 may be formed of a plurality of bays 20 defined by the distance between ground pile support structures 18 (generally referenced herein as piles 18). The ground piles 18 may be disposed in spaced relation to one another and partially embedded in the earth. In some examples, the ground piles 18 may be multi-component tubular support members, or A-frame supports, and/or may be configured to couple to A-frame supports. The piles 18 may have one or more embedments in the ground, such as one for each leg of an A-frame support where the embedments are spaced apart in the east-west direction. Alternatively, piles 18 may be a conventional solar I-beam known in the art as an H-pile. FIG. 1 illustrates two bays 20 of the solar tracker 10. However, it will be appreciated that the solar tracker 10 may include four bays, six bays, ten bays, twenty bays, or any other suitable number of bays as desired. At each pile 18 is either a bearing 22 or, generally near the center of the solar tracker 10, a drive mechanism 16. Each of the bearings 22 and the drive mechanism 16 are supported by one of the piles 18. Activation of the drive mechanism rotates a torque tube 14 about an axis of rotation and thus rotates one or more solar modules 12 mounted to the torque tube 14 such that the solar modules 12 can be oriented to a desired position. That desired position may be to a position to capture maximum sunlight based on the location of the sun in the sky, that position may be to a 0-angle position during times of diffuse light, the desired position may be a safety position based on weather conditions such as high winds or a snow storm, or any position in between as desired by the operators of the solar power plant in which the solar tracker 10 is located given the current weather and atmospheric conditions, the current demands of the grid, and other factors. The bearings 22 reduce to the extent possible the resistance to movement of the torque tube 14 and the solar modules 12.

The torque tube 14 is sized (e.g., diameter, wall thickness, material) such that sag between the piles 18 is reduced and to absorb torsional loads applied to the torque tube 14 by wind loading. In addition, since there is often just a single drive mechanism 16, the specifications for the torque tube 14 may desire to eliminate twist of the torque tube 14 along its length. Any twist would result in the solar modules 12 being oriented differently from what is desired, and thus again reduce the output and efficiency of the solar tracker 10, particularly, as the solar tracker 10 is rotated to the extreme angles of permitted range (e.g., +/−75 degrees or more), for example, during stowing.

As will be appreciated, the solar modules 12 must be supported on the torque tube 14. This is typically achieved by a bracket system (not shown in FIG. 1) that is attached to the torque tube 14 substantially perpendicular to the longitudinal axis of the torque tube 14. The torque tube 14 may be rotatable about its longitudinal axis to adjust an angular orientation of the solar modules 12 relative to the sun, while supporting the solar modules 12 on the bracket system. The bracket system may take many forms including two pieces of shaped steel, which may be arranged to sandwich the solar modules 12, and may be configured to connect to a rail, which is then coupled to the torque tube 14.

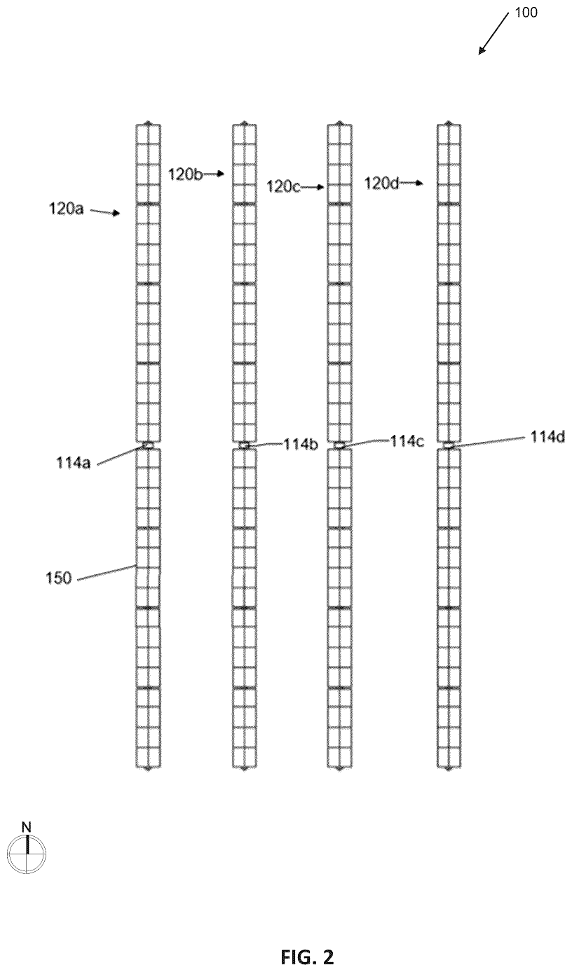

FIG. 2 is a top view of a solar tracker system 100 composed of a plurality of solar tracker rows, such as for example, a first solar tracker row 120a, a second solar tracker row 120b, a third solar tracker row 120c, and a fourth solar tracker row 120d (generally referred to herein as solar tracker rows 120). The solar tracker rows 120 may be arranged in parallel in a north-south direction, as shown in FIG. 2. It will be appreciated that directional language, e.g., north, south, east, west, referenced herein, is referring generally to such directions and not necessarily to the precise direction. For example, north-south, east-west directions may mean true north-south, true east-west, or approximately north, approximately south, approximately east, or approximately west, for example, within a ±44° range of true north-south, east-west. In some cases, the solar tracker rows 120 may include interior solar tracker rows, such as for example, solar tracker rows 120b, 120c, and exterior solar tracker rows, such as for example, solar tracker rows 120a, 120d. It will be appreciated that interior solar tracker rows are solar tracker rows 120 positioned between two other solar tracker rows 120, and exterior solar tracker rows are solar tracker rows 120 with one other solar tracker row 120 on one side of the exterior solar tracker row and no solar tracker row 120 positioned on the other side, opposite the one side of the exterior solar tracker row. The solar tracker rows 120 may be composed of a plurality of solar module assemblies 150 arranged in a north-south longitudinal orientation to form the solar tracker rows 120. The solar module assemblies 150 may include a plurality of solar modules, such as the solar modules 12, as in FIG. 1. Each one of the plurality of solar module assemblies 150 may be supported on a torque tube 114a, 114b, 114c, 114d (generally referred to herein as torque tube 114), which in turn is supported by a plurality of support piers (not explicitly shown in FIG. 2). The torque tube 114 may be an example of the torque tube 14, as in FIG. 1. As shown, the solar tracker rows 120 may be separated by a space sufficient to allow machinery to travel therethrough to allow for cleaning and maintenance.

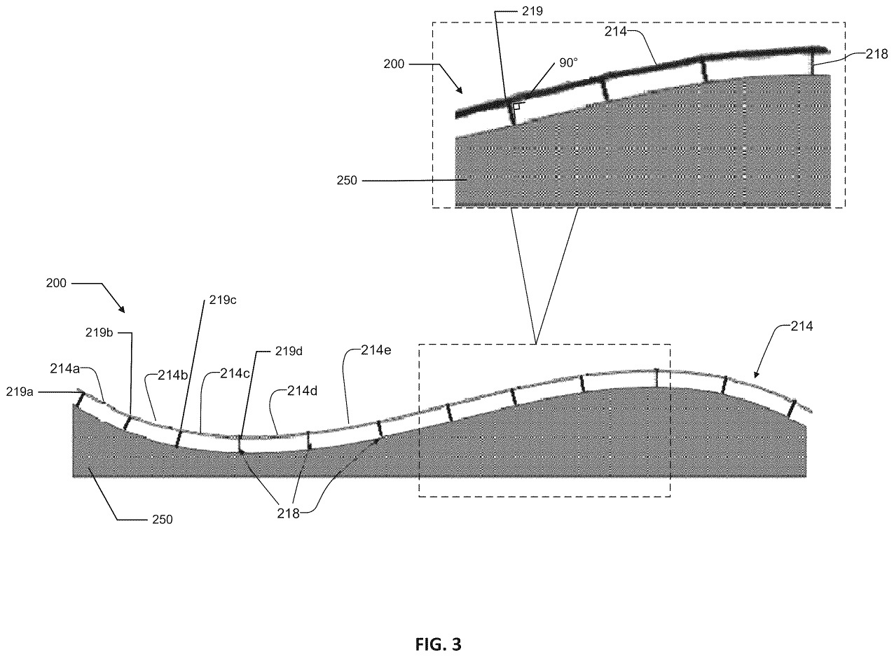

FIG. 3 is a profile view of a solar tracker 200 on terrain 250 of varying contour. As can be seen in FIG. 3, the solar tracker 200 follows the contours of the terrain 250. As further seen, in FIG. 3, the solar tracker 200 may include a continuous torque tube 214, and a plurality of piers 218 may be embedded in the terrain 250 at spaced locations along the continuous torque tube 214 to form a row. The torque tube 214 may be an example of torque tube 14, as in FIG. 1 and/or torque tube 114, as in FIG. 2. The plurality of piers 218 may be an example of the piles 18, as in FIG. 1. Although not explicitly shown in FIG. 3, a plurality of solar panels may be coupled to the continuous torque tube 214 (e.g., as shown in FIGS. 1 and 2).

In some examples, each pier of the plurality of piers 218 may include a top portion 219. The top portion 219 of each of the plurality of piers 218 may be at differing heights relative to each other due to the terrain 250 having a varying contour. However, the reveal of each of the plurality of piers 218 may be the same or substantially the same. That is, each pier 218 may extend from the ground the same amount or substantially the same amount. The result is that the tops of the piers 218, and the torque tube 214 supported on those piers 218 will follow the contours of the terrain 250. In accordance with one aspect of the disclosure the change in slope along the torque tube 214 can be up to about 0.75 degrees per bay and a pier-to-pier height differential of about 10.5 cm. Moreover, the continuous torque tube may bend from a typical linear path to curve to accommodate the connections to top portions of piers at differing heights.

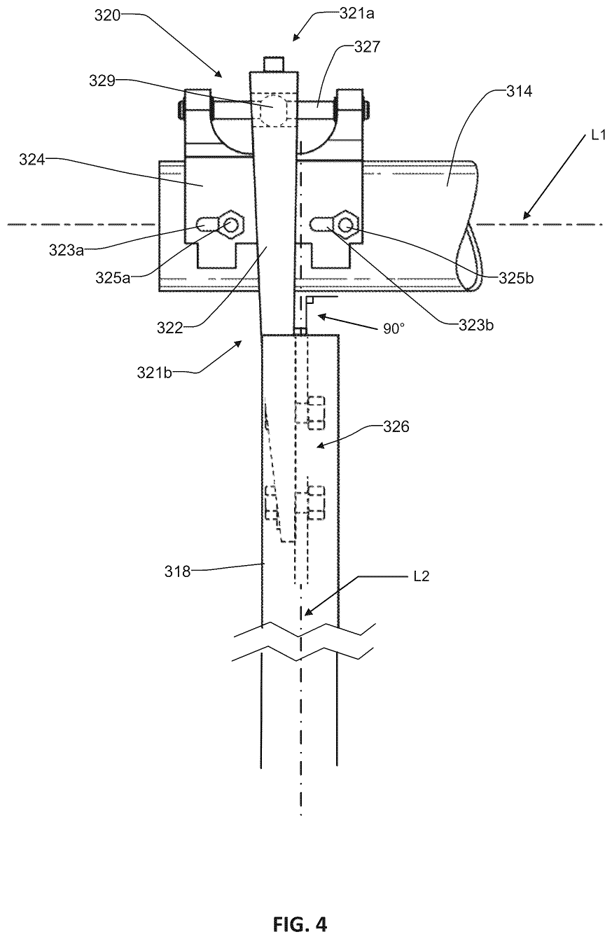

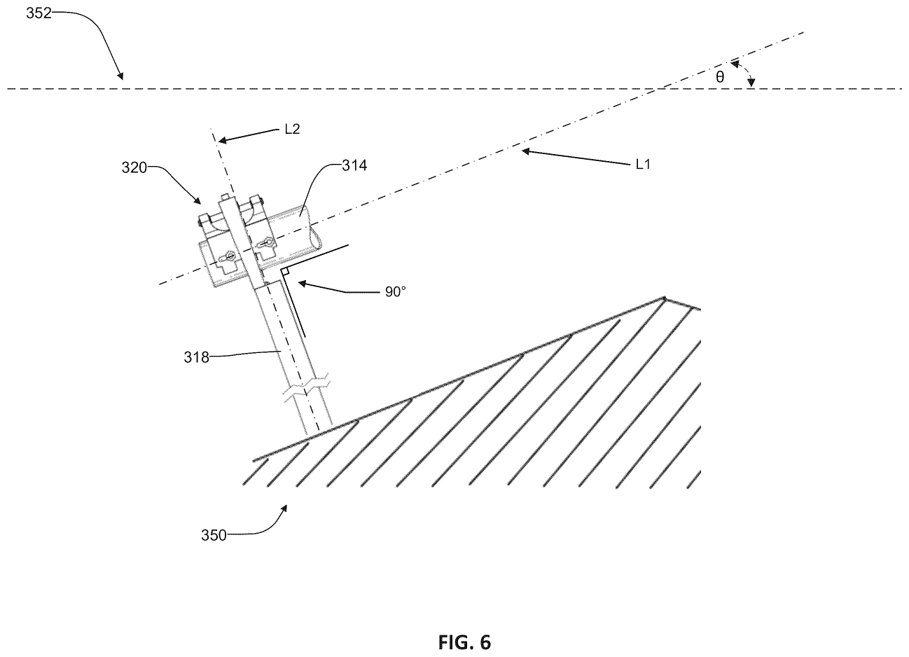

In some examples, each pier of the plurality of piers 218 may be mounted into the terrain 250 of varying contour at a mounting angle that is substantially 90 degrees downward from a pitch angle of a central axis proximate a location along the continuous torque tube 214 where the pier 218 is rotatably supported by a respective bearing, as will be discussed further with reference to FIG. 4. In some examples, some of the plurality of piers 218 may be mounted into the terrain 250 at a non-zero angle relative to plumb, as shown further in reference to FIGS. 6 to 8.

The torque tube 214 is typically formed of a round, square, rectangular, or D-shaped tube. The torque tube 214 described herein may be a continuous torque tube 214 formed of a plurality of sections. In some examples, each of the plurality of sections of torque tube 214 may include one end that is swaged and one end that is unswaged. The swaged end is such that a portion of its outer diameter is compressed to fit into an inner diameter of an unswaged portion of an adjacent one of the plurality of sections of torque tube 214. The plurality of sections of torque tube 214 together form the continuous torque tube 214. These over lapping sections (e.g., having a double wall thickness) are typically placed proximate the piers 218 where the highest bending moments are experienced, thus the doubling of the wall enables the individual wall thickness of the torque tube 214 to be reduced. Moreover, the continuous torque tube may bend to adapt to mountings to the top portions of piers of differing heights relative to each other.

In some examples, a first section 214a of the plurality of sections of the torque tube 214 may extend from the top portion 219a of a first pier of the plurality piers 218 to the top portion 219b of a second pier of the plurality of piers 218. In some examples, the first section 214a of the plurality of sections of the torque tube 214 may extend from the top portion 219a of a first pier of the plurality piers 218 to the top portion 219c of a third pier of the plurality of piers 218. In other examples, the first section 214a of the plurality of sections of the torque tube 214 may extend from the top portion 219a of a first pier of the plurality piers 218 to the top portion 219d of a fourth pier of the plurality of piers 218. Further, a second section 214b of the plurality of sections may extend from the top portion 219b of the second pier to the top portion 219c of a third pier of the plurality of piers 218. In other examples, the second section 214b of the plurality of sections may extend from the top portion 219b of the second pier to the top portion 219d of a fourth pier of the plurality of piers 218. The difference in heights of the top portions 219a, 219b, 219c of the first pier, second pier, and third pier relative to each other may cause bending along a length of the first section 214a, the second section 214b, and/or a third section 214c. Additionally, the difference in heights of the top portions 219a, 219b, 219c of the first pier, second pier, and third pier relative to each other may resulting in a non-zero relative angle between the first section 214a and the second section 214b to enable the torque tube 214 to follow variations in the terrain 250 of varying contour. While it is described that there is a first section and a second section, it may be contemplated that there are any number of sections as so desired. Further, while the top portions 219a, 219b, 219c, 219d have been described herein, it will be appreciated that the description further applies to top portions of any one of the plurality of piers 218.

In some examples, the continuous torque tube 214 may extend along and may be rotatably supported at spaced locations along the continuous torque tube 214 by a plurality of bearings, as shown in FIG. 4. In such examples, the continuous torque tube 214 and a pitch angle of a central axis of the torque tube 214 may follow the differing heights of the top portions 219 of the plurality of piers 218. The pitch angle of the central axis may be defined as the angle of the central axis relative to a horizon 352.

The torque tube 214, when mounted in the bearings or to the drive mechanism that are respectively mounted on the piers 218 that are at difference heights relative to one another, may result in pre-loading of the torque tubes 214. This pre-loading, caused by bending the torque tube 214 to conform to the piers allows the torque tube 214 to follow the terrain, as shown in FIG. 3. Pre-loading the first section 214a to form a relative angle between the first section 214a and the second section 214b may enable the torque tube 214 to follow variations in the terrain 250 of varying contour. While the pre-loading of the torque tube 214 requires force to achieve, the time and energy required to pre-load the torque tubes 214 is significantly less than that required to grade the earth to create a level grade. Further, the use of a common reveal of the piers 218 makes sourcing of the piers 218 easier as they can be manufactured to a common length and at the site no sorting or ensuring that the correct pier 218 is being employed at any single location. Rather the common length piers 218 can simply be embedded in the ground one after the other with no consideration of where in the site the pier 218 is being placed.

In some examples, the solar tracker 200 may primarily follow the terrain 250, as depicted in FIG. 3, however where necessary, for example, where the change in elevation of the terrain 250 would require applying application of stresses that exceed the tolerances of the torque tube 214. In such instances, an array may include selective piers 218 that are designed to have a greater reveal than the otherwise standard pier 218 that is used in terrain 250 of varying contour. However, due to the ability to pre-load the torque tubes 218 to follow the terrain 250, the number and frequency of these non-standard piers 218 can be greatly reduced as compared to when seeking to maintain the torque tube 214 substantially parallel to the ground. In this way, the specialized piers 218 that are needed for a particular site can be greatly reduced, and these can be specially noted and installed separately from the remainder of the piers 218 in the array.

FIG. 4 is a side view of an enlarged view of a clamp assembly 320 coupled to the solar tracker pier 318, including a portion of the torque tube 314. The pier 318 may be an example of pier 18, 218 as discussed above, and the torque tube 314 may be an example of torque tube 14, 114, 214 discussed above. The torque tube 314 may be a continuous torque tube formed from a plurality of sections, as described with reference to FIG. 3. The continuous torque tube 314 may define a central axis L₁ extending longitudinally therethrough. As discussed further herein, the central axis may be linear and non-linear (e.g., curved) as the continuous torque tube 314 is non-linear, a pitch or pitch angle of the central axis L₁ may change along the longitudinal extent of the continuous torque tube 314 as it traverses along uneven terrain. The clamp assembly 320 may include a clamp housing member 322 configured in an upright position, which may be understood to be a direction away from a direction of gravity. The clamp housing member 322 may include an upper region 321a and a lower region 321b.

The upper region 321a may include a bearing device 329 that allows for rotational, and movement in each of the three axis directions within a desirable range. The clamp assembly 320 may include a clam shell clamp member 324 coupled to the bearing device 329, and the clam shell clamp 324 may be suspended from the bearing device 329. That is, the clam shell clamp 324 has a first side and a second side (only one side is shown in FIG. 4). Each side of the clam shell 324 may be shaped to conform or couple to at least one side of a portion of the torque tube 314, as shown. Each side may one or more openings 323a, 323b, which align to one or more openings on the portion of the torque tube 314. One or more pins or bolts, e.g., bolts 325a, 325b, are inserted through each of the openings 323a, 323b, respectively, to clamp the clam shell clamp 324 to the portion of the torque tube 314 and surround substantially an entirety of a peripheral region of the torque tube 314. The bolts 325a, 325b may also hold the torque tube 314 in a fixed position relative to the clam shell clamp 324 to prevent the torque tube 314 from slipping and/or twisting within the clam shell clamp 324. Of course, there can be variations.

The lower region 321b may be configured to be coupled to the pier 318. The lower region 321b may include a thickness of material comprising bolt openings, which align to openings on an upper portion of the pier 318, although this is not explicitly shown. The lower region may include a plurality of bearings 326. Each bearing of the plurality of bearings 326 may be fixedly mounted to the top portion 319 of a respective pier of the plurality of piers, e.g., pier 318. The bearings 326 may be configured to hold the lower region 321b of the clamp housing member 322 in an upright manner, such that the solar tracker pier 318 and the torque tube 314 may be aligned perpendicular to one another at substantially a 90-degree angle. This is just an example. The clamp assembly 320 may be configured to be coupled to the pier 318 via welding, crimping, or any other suitable form of attachment strong enough to hold the clamp assembly 320 in an upright manner, such that the solar tracker pier 318 and the torque tube 314 may be aligned perpendicular to one another at a mounting angle that is substantially 90 degrees downward from a pitch angle of the central axis L₁. In some examples, the mounting angle may be ±2.5 degrees from 90 degrees, thereby the mounting able may be substantially a 90-degree angle. While it is shown that the torque tube 314 is coupled to the pier 318 via a clamp assembly 320, it may be contemplated that any other suitable fastening assembly may be used. Such as, for example, a strap assembly, a pin fastening assembly, or the like.

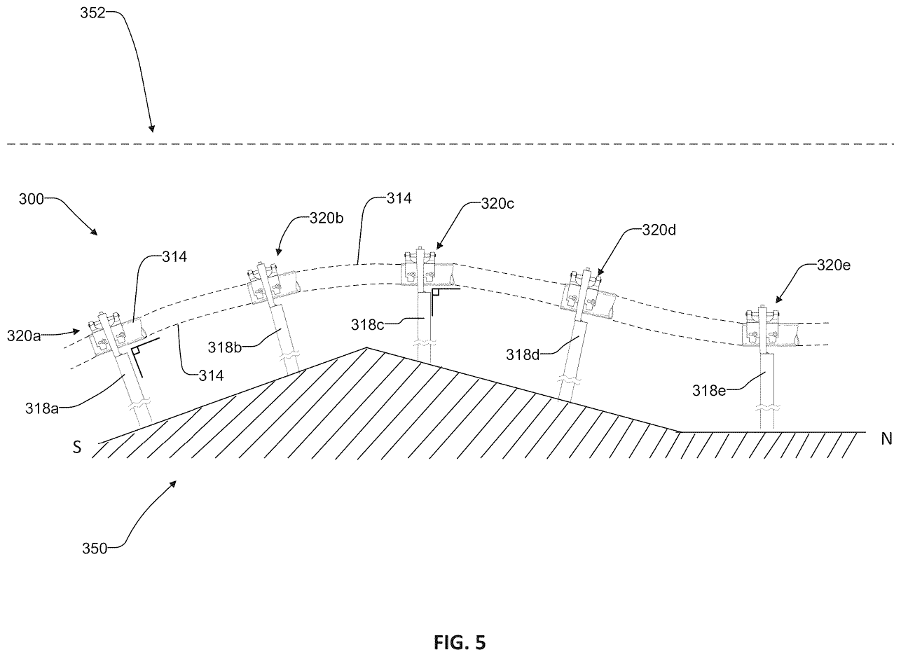

FIG. 5 is an enlarged profile view of a solar tracker 300 located on terrain 350 of varying contour. The solar tracker 300 may be like the solar tracker 200, as in FIG. 3. As can be seen in FIG. 5, the solar tracker 300 follows the contours of the terrain 350. As further seen, in FIG. 5, the solar tracker 300 may include a continuous torque tube 314, and a plurality of piers 318 may be embedded in the terrain 350 at spaced locations along the continuous torque tube 314 to form a row. The torque tube 314 may be an example of torque tube 214, as in FIG. 3. The plurality of piers 318 may be an example of the piers 218, as in FIG. 3. Although not explicitly shown in FIG. 5, a plurality of solar panels may be coupled to the continuous torque tube 314 (e.g., as shown in FIGS. 1 and 2).

In some examples, each pier of the plurality of piers 318 may include a top portion 319. The top portion 319 of each of the plurality of piers 318 may be at differing heights relative to each other due to the terrain 350 having varying contour. However, the reveal of each of the plurality of piers 318 may be the same. That is, each pier 318 may extend from the ground the same amount. The result is that the tops of the piers 318, and the torque tube 314 supported on those piers 318 may be substantially parallel with the contours of the terrain 350. In accordance with one aspect of the disclosure the change in slope along the torque tube 214 can be up to about 0.75 degrees per bay and a pier-to-pier height differential of about 10.5 cm.

In some examples, each pier of the plurality of piers 318 may be mounted into the terrain 350 of varying contour at a mounting angle that is substantially 90 degrees downward from a pitch angle of a central axis proximate a location along the continuous torque tube 314 where the pier 318 is rotatably supported by a respective bearing, as was discussed with reference to FIG. 4. In some examples, some of the plurality of piers 318 may be mounted into the terrain 350 at a non-zero angle relative to plumb, as shown further in reference to FIGS. 6 to 8.

The torque tube 314 is typically formed of a round, square, rectangular, or D-shaped tube. The torque tube 314 described herein may be a continuous torque tube 314 formed of a plurality of sections. In some examples, each of the plurality of sections of torque tube 314 may include one end that is swaged and one end that is unswaged. The swaged end is such that a portion of its outer diameter is compressed to fit into an inner diameter of an unswaged portion of an adjacent one of the plurality of sections of torque tube 314. The plurality of sections of torque tube 314 together form the continuous torque tube 314. These over lapping sections (e.g., having a double wall thickness) are typically placed proximate the piers 318 where the highest bending moments are experienced, thus the doubling of the wall enables the individual wall thickness of the torque tube 314 to be reduced. It will be appreciated that the plurality of sections of the torque tube 214, with reference to FIG. 3, further applies to the plurality of sections of torque tube 314.

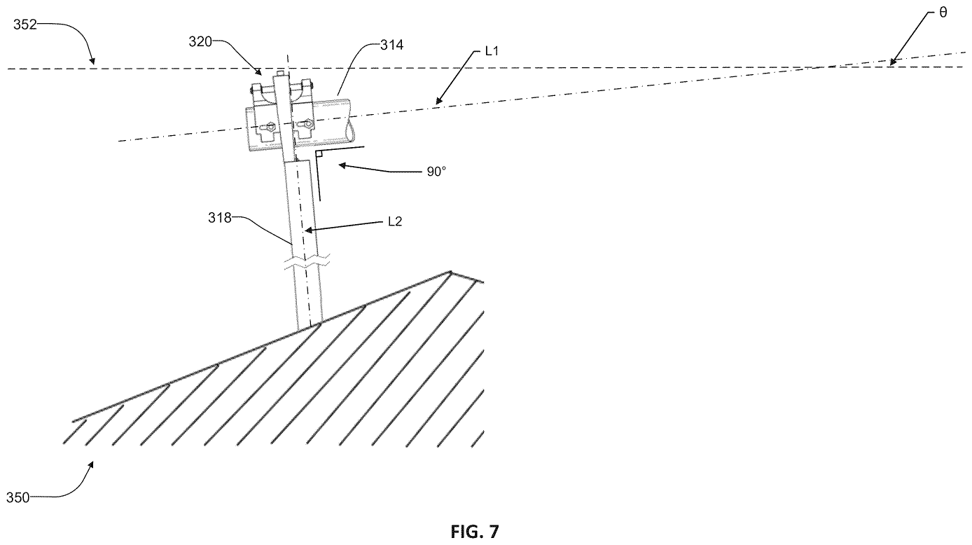

In some examples, the continuous torque tube 314 may extend along and may be rotatably supported at spaced locations along the continuous torque tube 314 by a plurality of bearings, as shown in FIG. 4. In such examples, the continuous torque tube 314 and a pitch angle of a central axis L₁ of the torque tube 314 may follow the differing heights of the top portions of the plurality of piers 318, as shown in FIG. 5. The pitch angle of the central axis L₁ may be defined as the angle of the central axis L₁ relative to the horizon 352, as indicated by angle θ in FIGS. 6 and 7. In an aspect of the design, angles of substantially 90-degrees are maintained between the pitch of the central axis L₁ and the longitudinal axis L₂ of the respective underlying pier 318. The substantially 90-degree angle between the pitch of the central axis L₁ and a longitudinal axis L₂ of the pier 318 does not necessarily dictate that the angle between the pier 318 and the ground 350 will also be 90-degrees.

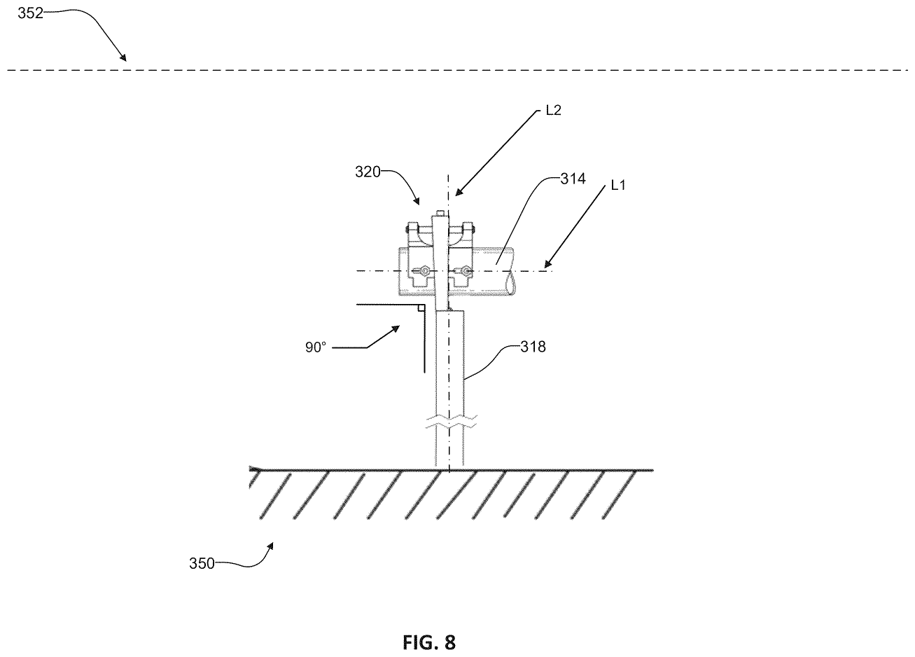

On flat ground the angle between the pier 318 and the ground 350 will generally be 90-degrees, as shown in FIGS. 5 and 8. In some instances of ground of uneven terrain, the angle between the pier 318 and the ground will be 90-degrees. That is, a line drawn parallel with the terrain delta from North to South on either side of the piers 318 will form an angle of 90-degrees with the central longitudinal axis L₂ of the pier 318. However, in many instances where piers 318 are embedded in uneven terrain, the angle between the pier 318 and the ground 350 will not be 90 degrees.

In some examples, the solar tracker 300 may primarily follow the terrain 350, as depicted in FIG. 5, however where necessary, for example, where the change in elevation of the terrain 350 would require applying application of stresses that exceed the tolerances of the torque tube 314. In such instances, an array may include selective piers 318 that are designed to have a greater reveal than the otherwise standard pier 318 that is used in terrain 350 of varying contour. However, due to the ability to pre-load the torque tubes 318 to follow the terrain 350, the number and frequency of these non-standard piers 318 can be greatly reduced as compared to when seeking to maintain the torque tube 314 substantially parallel to the ground. In this way, the specialized piers 318 that are needed for a particular site can be greatly reduced, and these can be specially noted and installed separately from the remainder of the piers 318 in the array.

FIG. 6 is an enlarged view of a portion 320a of the solar tracker 300 including a first section 314a of the torque tube 314 on the terrain 350, FIG. 7 is an enlarged view of a portion 320b of the solar tracker 300 including a second section 314b of the torque tube 314 on the terrain 350, and FIG. 8 is an enlarged view of a portion 320e of the solar tracker 300 including a fifth section 314e of the torque tube 314 on the terrain 350. As previously discussed, the continuous torque tube 314 and a pitch of the central axis L₁ of the torque tube 314 may follow the differing heights of the top portions of the plurality of piers 318. The pitch angle of the central axis L₁ may be defined as the angle of the central axis L₁ relative to the horizon 352, as indicated by angle θ in FIGS. 6 and 7. The pitch angle θ of the central axis L₁ may be calculated for each pier 318 point to take into account a terrain delta from North to South on either side of the piers 318. Using angles of substantially 90-degrees between the pitch of the central axis L₁ and the longitudinal axis L₂ of the respective underlying pier 318 may minimize mechanical interference between bays of the torque tube 314 at points where terrain 350 changes are relatively greater. Further, using angles of substantially 90-degrees between the pitch of the central axis L₁ and the longitudinal axis L₂ of the respective underlying pier 318 may provide more structural rigidity as any type of North to South slide load is minimized. The pitch angle θ varies as the torque tube 314 extends along the uneven terrain 350 since the tops of the piers 318 which support the torque tube 314, vary in height relative to each other. The pitch angle θ often will not exceed +45 degrees. Although, greater pitch angles are theoretically possible.

While it is shown that the pitch angle θ of the central axis L₁ may vary relative to the horizon, the mounting angle of the torque tube 314 relative to the pier 318 may not vary and may remain substantially at a 90-degree angle, as indicated by the right-angle sign in FIGS. 3 to 8. Maintaining a substantially 90-degree angle between the torque tube 314 and the pier 318 may minimize torsional loads applied by wind loading, and/or other stresses such as weight, position of the solar module, or the like.

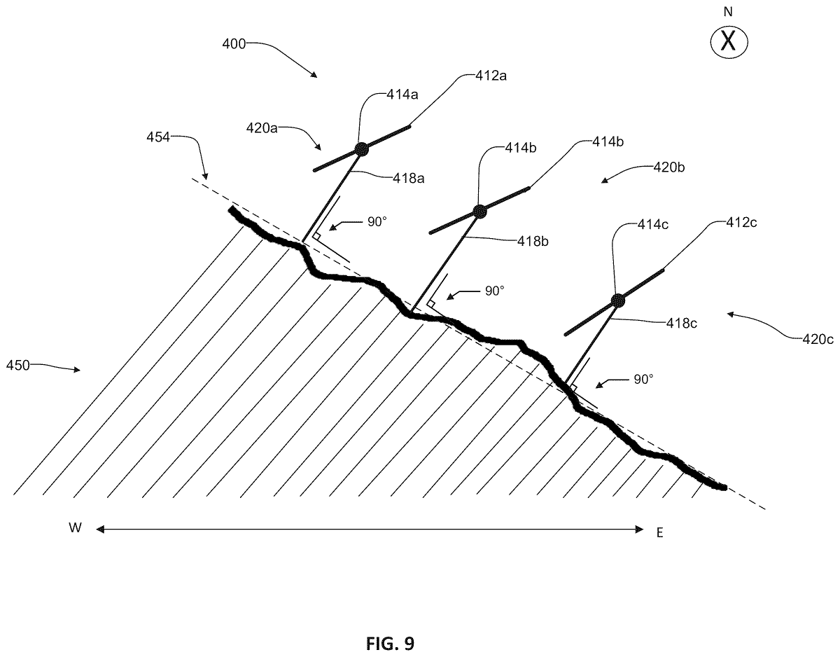

FIG. 9 is a profile view of a solar tracking system 400 on a sloping terrain 450. The solar tracking system may be composed of a plurality of solar tracker rows, such as for example, a first solar tracker row 420a, a second solar tracker row 420b, and a third solar tracker row 420c, (generally referred to herein as solar tracker rows 420). The solar tracker rows 420 may be arranged in parallel in a north-south direction, as indicated in FIG. 9. The solar tracker rows 420 may be composed of a plurality of solar modules assemblies 412a, 412b, 412c (generally referred to herein as solar module assemblies 412) arranged in a north-south longitudinal orientation to form the solar tracker rows 420. The solar module assemblies 412 may include a plurality of solar modules, such as the solar modules 12, as in FIG. 1. Each one of the plurality of solar module assemblies 412 may be supported on a torque tube 414a, 414b, 414c (generally referred to herein as torque tube 414), which in turn is supported by a plurality of support piers 418a, 418b, 418c (generally referred to herein as support piers 418).

It will be appreciated that the solar tracking system 400, solar module assemblies 412, torque tube 414, and support piers 418 are like the solar tracking system 100, 200, 300, solar module assemblies 412 are like solar module assemblies 150, the torque tube 414 is like the torque tube 14, 114, 214, 314, and the support piers are like the support piers 18, 118, 218, 318, described herein. The solar tracking system 400 differs in that the support piers 418 may be mounted into the sloping terrain 450 at a non-zero angle. As shown in FIG. 9, the support piers 418 may be positioned at a substantially 90-degree angle relative to the underlying sloping terrain 450 in an east-west direction, as indicated by the right-angle sign. In some examples, one support pier (e.g., 418a. 418, 418c) of each of the solar tracker rows 420 may be positioned at a substantially 90-degree angle relative to the underlying sloping terrain 450 in an east-west direction. In other examples, the support piers 418 in the solar tracker rows 420 may maintain an average of a 90-degree angle relative to an approximate slope 454 of the sloping terrain 450 (e.g., the underlying sloping terrain 450).

Various non-limiting exemplary embodiments have been described. It will be appreciated that suitable alternatives are possible without departing from the scope of the examples described herein.

1. A solar tracker located on terrain of varying contour, comprising:
a continuous torque tube formed of a plurality of sections, the plurality of sections being interconnected and having one end which is swaged and another end unswaged such that the swaged ends are inserted in the unswaged ends to form the continuous torque tube, the continuous torque tube defining a central axis extending longitudinally therethrough,
a plurality of piers embedded in terrain of varying contour at spaced locations along the continuous torque tube to form a row, each pier of the plurality of piers having a top portion, the top portions of the plurality of piers being at differing heights relative to each other due to the terrain of varying contour;
a plurality of bearings, each bearing of the plurality of bearings fixedly mounted to the top portion of a respective pier of the first plurality of piers;
the continuous torque tube extending along and rotatably supported at the spaced locations along the continuous torque tube by the plurality of bearings such that the continuous torque tube and a pitch angle of the central axis follow the differing heights of the top portions, the pitch angle of the central axis being defined as the angle of the central axis relative to the horizon,
each pier being mounted into the terrain of varying contour at a mounting angle that is substantially 90 degrees downward from the pitch angle of the central axis proximate a location along the continuous torque tube where the continuous torque tube is rotatably supported by a respective bearing.

2. The solar tracker of claim 1, further comprising:
a first section of the plurality of sections extending from the top portion of a first pier of the first plurality of piers to the top portion of a second pier of the plurality of piers; and a second section of the plurality of sections extending from the top portion of the second pier to the top portion of a third pier of the plurality of piers, the difference in heights of the top portions of the first pier, second pier, and third pier relative to each other and causing bending along a length of the first section and pre-loading the first section to form a relative angle between the first section and the second section to enable the continuous torque tube to follow variations in the terrain of varying contour.

3. The solar tracker of claim 1, further comprising:
a first section of the plurality of sections extending from the top portion of a first pier of the first plurality piers to the top portion of a second pier of the plurality of piers; and
a second section of the plurality of sections extending from the top portion of the second pier to the top portion of a third pier of the plurality of piers, the difference in heights of the top portions of the first pier, second pier, and third pier relative to each other resulting in a non-zero relative angle between the first section and the second section to enable the torque tube to follow variations in the terrain of varying contour.

4. The solar tracker of claim 1, further comprising, a plurality of solar panels coupled to the continuous torque tube.

5. The solar tracker of claim 1, wherein the swaged ends inserted into the unswaged ends forms overlapping sections having a double-wall thickness.

6. The solar tracker of claim 1, wherein the overlapping sections are placed proximate the piers of the plurality of piers.

7. The solar tracker of claim 1, wherein the pitch angle of the central axis varies up to +60 degrees relative to the horizon.

8. The solar tracker of claim 1, wherein some of the plurality of piers are mounted into the terrain at a non-zero angle relative to plumb.

9. The solar tracker of claim 1, wherein the continuous torque tube is generally parallel to underlying terrain of varying contour.

10. A solar tracker located on terrain of varying contour, comprising:
a torque tube defining a central axis extending longitudinally therethrough,
a plurality of piers embedded in terrain of varying contour at spaced locations along the torque tube to form a row, each pier of the plurality of piers having a top portion, the top portions of the first plurality of piers being at differing heights relative to each other due to the terrain of varying contour;
a plurality of bearings, each bearing of the plurality of bearings fixedly mounted to the top portion of a respective pier of the first plurality of piers;
the torque tube extending along and rotatably supported at the spaced locations along the torque tube by the plurality of bearings such that the torque tube and a pitch angle of the central axis follow the differing heights of the top portions, the pitch angle of the central axis being defined as the angle of the central axis relative to the horizon,
each pier being mounted into the terrain of varying contour at a mounting angle that is substantially 90 degrees downward from the pitch angle of the central axis proximate a location along the torque tube where the torque tube is rotatably supported by a respective bearing.

11. The solar tracker of claim 10, wherein the pitch angle of the central axis varies up to +60 degrees relative to the horizon.

12. The solar tracker of claim 10, wherein some of the plurality of piers are mounted into the terrain at a non-zero angle relative to plumb.

13. The solar tracker of claim 10, wherein the torque tube is generally parallel to underlying terrain of varying contour.

14. A solar tracker located on terrain of varying contour, comprising:
a continuous torque tube including a first section and a second section, connected to the first section, the continuous torque tube defining a central axis extending centrally therethrough a plurality of piers, including, a first pier, a second pier, and a third pier, embedded in terrain of varying contour at spaced locations along the continuous torque tube to form a row, each pier of the plurality of piers having a top portion,
the first section extending from the top portion of the first pier to the top portion of the second pier, the second section extending from the top portion of the second pier to the top portion of the third pier, the top portion of the second pier being at a differing height relative to the top portion of the first pier and the top portion of the third pier due to the terrain of varying contour, the difference in heights of the top portions causing bending along a length of the first section and pre-loading the first section to form a relative angle between the first section and the second section to enable the continuous torque tube to follow variations in the terrain of varying contour;
a plurality of bearings, each bearing of the plurality of bearings fixedly mounted to the top portion of a respective pier of the first plurality of piers;
the continuous torque tube extending along and rotatably supported at the spaced locations along the continuous torque tube by the plurality of bearings such that the continuous torque tube and a pitch angle of the central axis follow the differing heights of the top portions, the pitch angle of the central axis being defined as the angle of the central axis relative to the horizon,
each pier of the plurality of piers being mounted into the terrain of varying contour at a mounting angle that is substantially 90 degrees downward from the pitch angle of the central axis proximate a location along the continuous torque tube where the continuous torque tube is rotatably supported by a respective bearing.

15. The solar tracker of claim 14, wherein the pitch angle of the central axis varies up to +60 degrees relative to the horizon.

16. The solar tracker of claim 14, wherein some of the plurality of piers are mounted into the terrain at a non-zero angle relative to plumb.

17. The solar tracker of claim 14, wherein the continuous torque tube is generally parallel to underlying terrain of varying contour.

18. The solar tracker of claim 14, wherein the top portion of the second pier being at a differing height relative to the top portion of the first pier and the top portion of the third pier due to the terrain of varying contour result in a non-zero relative angle between the first section and the second section to enable the torque tube to follow variations in the terrain of varying contour.
